(19) United States
(12) Patent Application Publication
(10) Pub. No.: US 2014/0019981 A1
(43) Pub. Date: Jan. 16, 2014

(54) SCHEDULING USER JOBS ACROSS TENANTS

(71) Applicants: Marc Boyer, Bellevue, WA (US); Cosmin Catrinescu, Woodinville, WA (US); Eliza Maria Sipos, Bothell, WA (US); Elena Popa, Redmond, WA (US); Andrew Cuneo, Seattle, WA (US)

(72) Inventors: Marc Boyer, Bellevue, WA (US); Cosmin Catrinescu, Woodinville, WA (US); Eliza Maria Sipos, Bothell, WA (US); Elena Popa, Redmond, WA (US); Andrew Cuneo, Seattle, WA (US)

(73) Assignee: MICROSOFT CORPORATION, Redmond, WA (US)

(21) Appl. No.: 13/547,735

(22) Filed: Jul. 12, 2012

(51) Int. Cl. G06F 9/46

(52) U.S. Cl. 718/102

(57) ABSTRACT

Jobs are scheduled per user across tenants in a multi-tenant environment. When a tenant is serviced, scheduling information is stored that indicates a servicing time of a user that remains unserviced after servicing the tenant. Each time a scheduler begins to schedule the servicing of tenants it obtains the list of the tenants. The scheduler sorts the tenants using the servicing information obtained from each of the tenants. The tenant that has the oldest unserviced user is serviced first. The scheduler starts servicing the first tenant in the sorted list and services as many jobs for as many users for that tenant based on the available processing resources. When the limit of servicing users for the tenant is reached and one or more users remain unserviced, the time for an unserviced user is stored in the servicing information.

### BACKGROUND

Job scheduling involves controlling resource allocation and allocating jobs. Job schedulers typically attempt to minimize latency time for jobs such that jobs are scheduled in a timely manner. Job schedulers, however, are limited by the available processing resources and maintaining a fair distribution of the execution of jobs can be difficult.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Jobs are scheduled per user across tenants in a multi-tenant environment. When a tenant is serviced, scheduling information is stored that indicates a servicing time of a user that remains unserviced after servicing the tenant. Each time a scheduler begins to schedule the servicing of tenants it obtains the list of the tenants. The scheduler sorts the tenants using the servicing information obtained from each of the tenants. The tenant that has the oldest unserviced user is serviced first. The scheduler starts servicing the first tenant in the sorted list and services as many jobs for as many users for that tenant based on the available processing resources. When the limit of servicing users for the tenant is reached and one or more users remain unserviced, the time for an unserviced user is stored in the servicing information. When resources become available, the scheduler continues through the tenants in the sorted list until each of the tenants has been serviced.

### BRIEF DESCRIPTION OF THE DRAWINGS

FIG. 1 illustrates an exemplary system for scheduling user jobs across tenants;

FIG. 2 illustrates a multi-tenant system for scheduling user jobs across tenants;

FIG. 3 shows a process for choosing a tenant to service based on servicing information;

FIG. 4 illustrates a process for setting servicing information based on servicing a tenant; and

FIGS. 5-7 and the associated descriptions provide a discussion of a variety of operating environments in which embodiments of the invention may be practiced.

### DETAILED DESCRIPTION

Referring now to the drawings, in which like numerals represent like elements, various embodiments will be described.

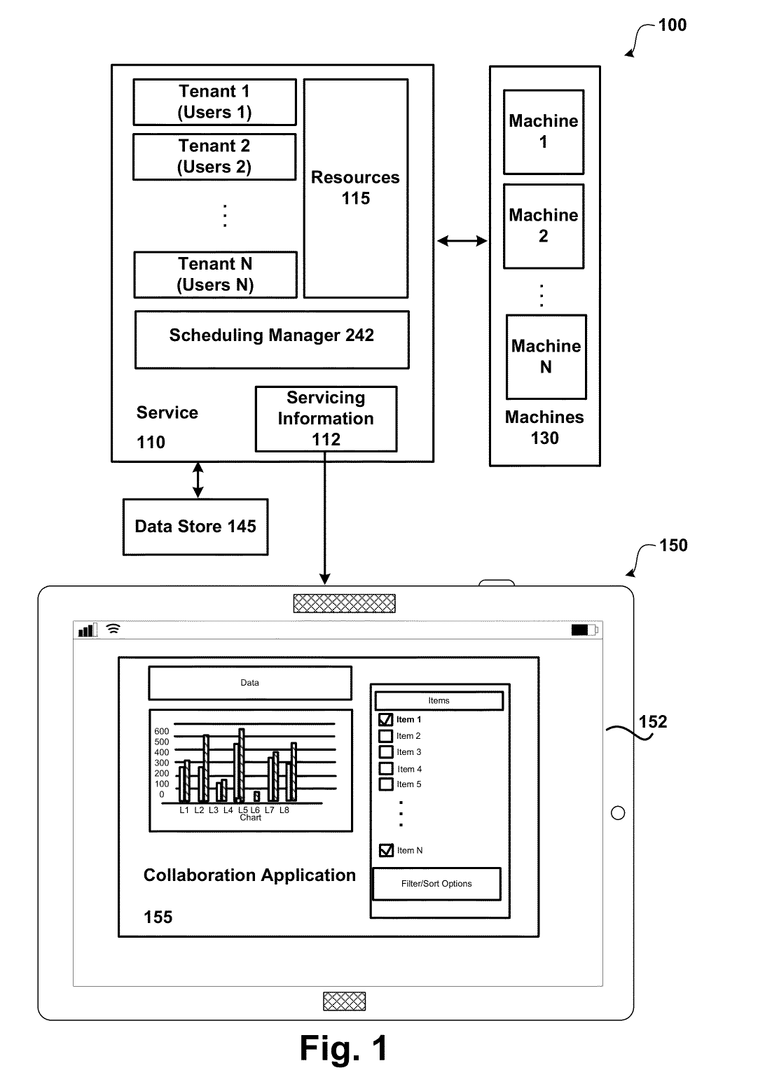

FIG. 1 illustrates an exemplary system for scheduling user jobs across tenants. As illustrated, system 100 includes service 110, machines 130 for servicing tenants, data store 145, and computing device 150 (e.g. a slate as shown, a desktop computing device, a mobile computing device, and the like).

As illustrated, service 110 is a cloud based and/or enterprise based service that may be configured to provide services, such as collaboration services (e.g. MICROSOFT SHAREPOINT) and/or productivity services (e.g. MICROSOFT OFFICE 365 or some other cloud based/online service that is used to interact with items (e.g. data, messages, spreadsheets, documents, charts . . . )), graphic services, web-based applications, and the like. The service may be interacted with using different computing devices (e.g. desktop, mobile) using different types of input/output. For example, a user may use touch input, hardware based input, speech input, and the like. Functionality of one or more of the services/applications provided by service 110 may also be configured as a client/server based application. For example, a client device may include an application that performs collaboration operations. Although system 100 shows a service 110 relating to collaboration applications, other services/applications may be configured.

As illustrated, service 110 is a multi-tenant service that provides resources 115 and services to any number of tenants (e.g. Tenants 1-N). Each tenant may include one or more users. For example, one tenant may include 100 users whereas another tenant has 10,000 users. Multi-tenant service 110 is a cloud based service that provides resources/services 115 to tenants subscribed to the service and maintains each tenant's data separately and protected from other tenant data.

System 100 as illustrated comprises device 150 (e.g. a touch screen input device/display such as a slate/tablet device) that detects when a touch input has been received (e.g. a finger touching or nearly touching the touch screen). Any type of touch screen may be utilized that detects a user's touch input. For example, the touch screen may include one or more layers of capacitive material that detects the touch input. Other sensors may be used in addition to or in place of the capacitive material. For example, Infrared (IR) sensors may be used. According to an embodiment, the touch screen is configured to detect objects that in contact with or above a touchable surface. Although the term “above” is used in this description, it should be understood that the orientation of the touch panel system is irrelevant. The term “above” is intended to be applicable to all such orientations. The touch screen may be configured to determine locations of where touch input is received (e.g. a starting point, intermediate points and an ending point). Actual contact between the touchable surface and the object may be detected by any suitable means, including, for example, by a vibration sensor or microphone coupled to the touch panel. A non-exhaustive list of examples for sensors to detect contact includes pressure-based mechanisms, micro-machined accelerometers, piezoelectric devices, capacitive sensors, resistive sensors, inductive sensors, laser vibrometers, and LED vibrometers.

Device 150 includes one or more applications (e.g. application 155). For example, the devices may include one or more browser applications (e.g. MICROSOFT INTERNET EXPLORER) and one or more other applications (e.g. MICROSOFT SHAREPOINT, MICROSOFT OFFICE, and the like). Devices may also include other applications that are configured to connect to a web-based application/service. Device 150 may also be configured to receive text/speech input and output text/speech.

As illustrated, device 150 shows exemplary display 152. Display 152 shows the use of web-based application 155 by a user of a tenant accessing collaboration services (e.g. service 110) over a network, such as the Internet. For example, a user associated with device 150 may be using application 155 to view/edit collaboration data relating to functionality provided by a web based service 110 such as MICROSOFT SHAREPOINT. Many other types of web based applications may be accessed by one or more mobile computing devices. For example, a mobile device may access an online game, a spreadsheet application, a word processing application, a graphics application, and the like over a network. Data, such as servicing information 112, tenant information, may be stored on a device (e.g. device 150 and/or at some other location (e.g. network data store 145). The applications (e.g. 155) may access data on the client, on a server, from the cloud (e.g. service 110) and/or some combination.

Scheduling manager 242 is configured to perform operations relating to scheduling user jobs across tenants. While manager 242 is shown within service 110, the functionality of the manager may be included in other locations (e.g. on another computing device).

Scheduling manager 242 schedules user jobs across tenants in a multi-tenant environment. Scheduling manager 242 chooses a tenant to service (e.g. Tenant 1-N) based on servicing information relating to the tenants. When a tenant is serviced, scheduling information is returned and/or stored by the machine servicing the tenant (e.g. Machine 1-N) that indicates a servicing time of a user for that tenant that remains unserviced after the machine services the tenant. For example, a machine may not have the available resources to service each of the users for the tenant at a particular servicing time. As a result, some of the users for that tenant may remain unserviced. The servicing information includes a time of an unserviced user of the tenant. According to an embodiment, the time is for the first unserviced user that remains unserviced after the machine(s) servicing the tenant has reached its use of available resources. For example, when the machine(s) handling the servicing of the tenant reaches its available resources (e.g. a limit for the number of threads available for servicing is reached), a timestamp of the last serviced user is stored for the next to be serviced user within the servicing information.

Each time the scheduling manager 242 begins to service tenants it obtains a list of the tenants to service and sorts the tenants using the servicing information obtained from servicing each of the tenants. The tenant that has the oldest unserviced user as indicated by the servicing information 112 is processed first.

Scheduling manager 242 starts servicing the first tenant in the sorted list and services as many jobs for as many users for that tenant based on the available processing resources. According to an embodiment, the servicing of the tenants is done by sending a general servicing request to a machine (e.g. machines 1-N). When resources become available, the scheduling manager 242 continues through the tenants in the sorted list until each of the tenants has been serviced.

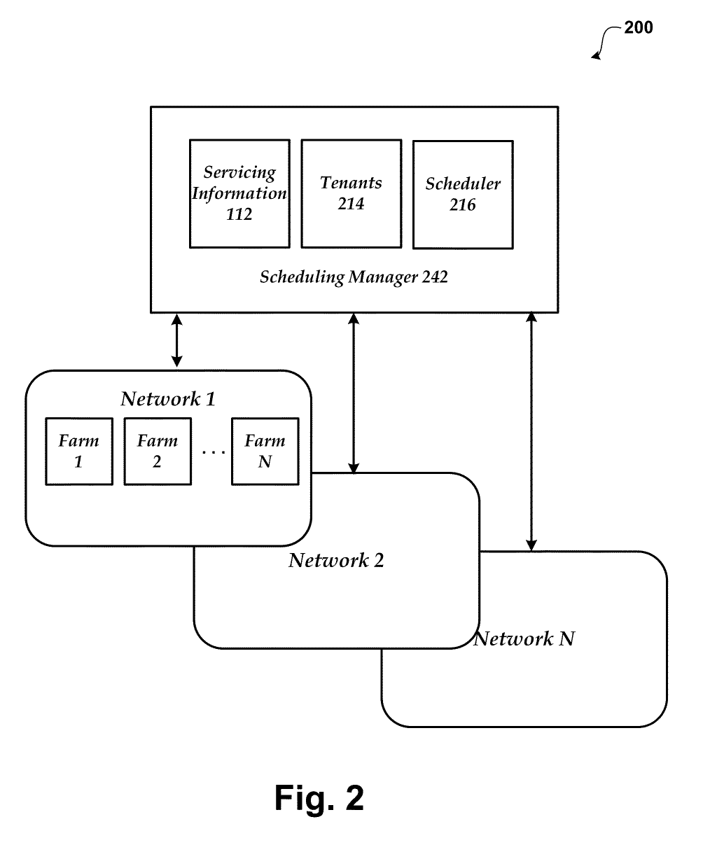

FIG. 2 illustrates a multi-tenant system for scheduling user jobs across tenants. System 200 illustrates scheduling manager 242 that is coupled to different networks. Each of the networks is configured to provide services for tenants (e.g. clients, customers). As illustrated, scheduling manager 242 comprises servicing information 112, tenants 214 and scheduler 216. Scheduling manager 242 performs operations relating to scheduling user jobs across tenants. According to one embodiment, scheduling manager 242 schedules user jobs for tenants relating to MICROSOFT SHAREPOINT.

As discussed above, scheduling manager 242 manages the execution of tasks and enables scheduling of user jobs across tenants. Scheduling manager 242 schedules the servicing for each tenant 214. According to one embodiment, the servicing of the tenants may be started by invoking one or more scripts. For example, a scripting language such as Microsoft's PowerShell® may be used to start servicing a tenant using one or more of the networks, changing settings, move data from one machine to another, moving tenants, and the like. Other programming implementations may be used to initiate servicing of tenants. For example, a programming language may be used to implement the functionality. Using PowerShell scripts allows a process to be started locally by scheduling manager 242 that may in turn start a process on a remote machine (i.e. a physical machine in one of the attached networks). According to an embodiment, scheduling manager 242 is configured to know about SharePoint Tenants, Site Collections, and the like.

Each network may be configured as a dedicated network for a tenant and/or as a multi-tenant network that services more than one tenant. The networks may include a changing number of physical/virtual machines with their configuration also changing after deployment.

Each network may include one or more farms (e.g. see Network 1). Farms are basic grouping of machines used to coordinate applications that need tightly bound relationships. For example, content farms may be deployed within each of the networks for a content management application, such as Microsoft SharePoint®. Generally, the set of machines in each of the farms provide web service and application server functions together.

According to an embodiment, scheduling manager 242 resides at a central location and is designed to do very little processing. For example, scheduling manager 242 is configured to be a timer job that wakes up and starts the servicing of the tenants using scheduler to request the servicing of a selected tenant without servicing the tenants itself. As discussed, scheduling manager 242 chooses an ordering of the servicing of the tenants based on servicing information 112. Scheduling manager 242 also stores the servicing information that includes a time of an unserviced user within each of the time in a memory (such as a data store (local and/or network), a cache, and the like).

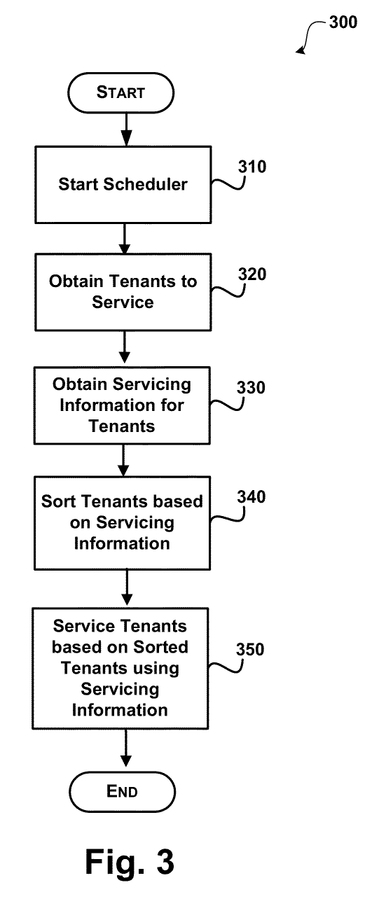

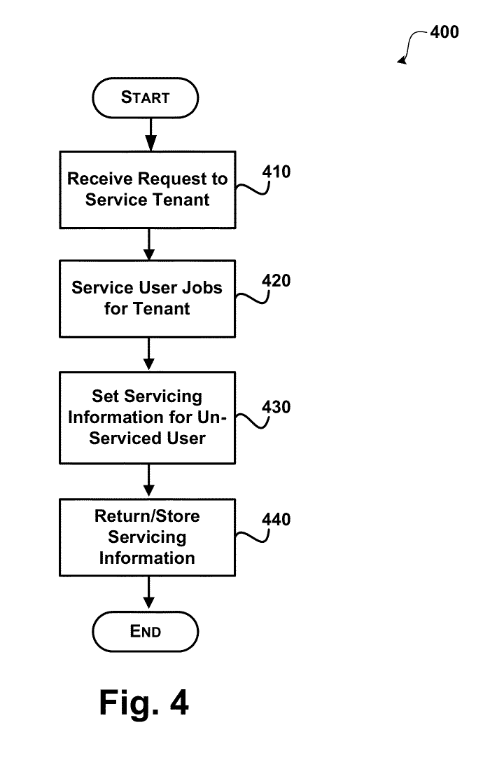

FIGS. 3-4 show illustrative processes for scheduling user jobs across tenants. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof

FIG. 3 shows a process 300 for choosing a tenant to service based on servicing information.

After a start operation, the process flows to operation 310 where the scheduler to schedule user jobs across tenants is started. According to an embodiment, the scheduler is a timer job that is configured to be automatically executed according to a predetermined schedule. The scheduler may also be manually started.

Moving to operation 320, the tenants to service are obtained. For example, a list of tenants that are to be serviced are obtained. The list may be stored in a data store and/or may be obtained using some other method. For example, a programming call may be made to the service to request a list of the tenants to service.

Flowing to operation 330, servicing information for the tenants in the list of tenants is obtained. When a tenant has not have been previously serviced, default servicing information for that tenant may be used (e.g. new tenant, never serviced). The default servicing information may set the servicing information such that the tenant is serviced first, serviced last, or serviced somewhere else within the list of tenants to service. According to an embodiment, when a tenant has been previously serviced, the servicing information includes a time of the first unserviced user within the tenant.

Transitioning to operation 340, the tenants are sorted based on the servicing information. According to an embodiment, the tenants are sorted such that the tenant having the oldest unserviced user that is next to service is positioned at the top of the sorted list.

Moving to operation 350, the tenants are serviced based on the ordering of the tenants in the sorted tenant list. Each tenant is serviced according to when available resources become available.

The process flows to an end operation and returns to processing other actions.

FIG. 4 illustrates a process 400 for setting servicing information based on servicing a tenant.

After a start operation, the process flows to operation 410, where a request to service a tenant is received. According to an embodiment, the servicing of tenants is performed by one or more separate machines that are independent from the scheduler. For example, the scheduler may simply send a request to a servicing process that indicates a name of the tenant to service.

Moving to operation 420, user jobs for the tenant are serviced. The user jobs may relate to different tasks (e.g. synchronizing data between the user and the service, checking a state of a task, moving data, and the like). The machine(s) servicing the tenant may not have available resources to be able to service all of the users for the tenant. For example, one hundred users out of two hundred users may be able to be serviced during a servicing session.

Flowing to operation 430, the servicing information for an unserviced user is set. According to an embodiment, the servicing information includes a time of the first unserviced user within the tenant being serviced.

Transitioning to operation 440, the servicing information is returned and/or stored for later use. For example, the machine servicing the tenant may return the servicing information to the scheduler and/or may store the servicing information within a memory (e.g. cache, data store) that is accessible by the scheduler.

The process then flows to an end operation and returns to processing other actions.

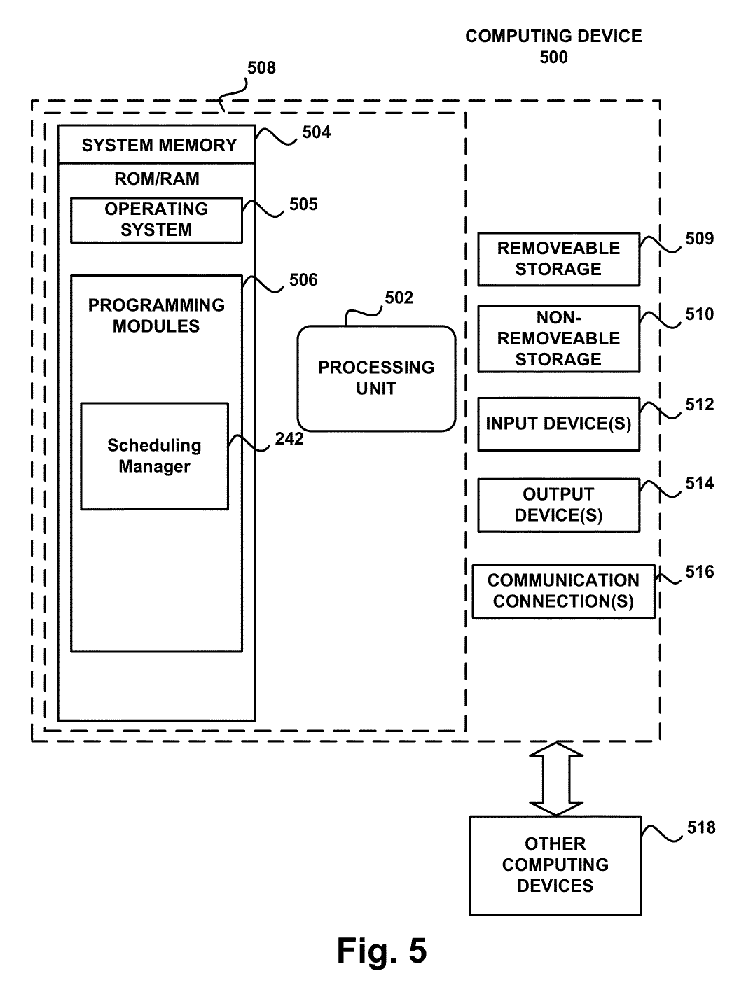

FIGS. 5-7 and the associated descriptions provide a discussion of a variety of operating environments in which embodiments of the invention may be practiced. However, the devices and systems illustrated and discussed with respect to FIGS. 5-7 are for purposes of example and illustration and are not limiting of a vast number of computing device configurations that may be utilized for practicing embodiments of the invention, described herein.

FIG. 5 is a block diagram illustrating example physical components of a computing device 500 with which embodiments of the invention may be practiced. The computing device components described below may be suitable for the computing devices described above. In a basic configuration, computing device 500 may include at least one processing unit 502 and a system memory 504. Depending on the configuration and type of computing device, system memory 504 may comprise, but is not limited to, volatile (e.g. random access memory (RAM)), non-volatile (e.g. read-only memory (ROM), magnetoresistive random-access memory (MRAM)), flash memory, or any combination. System memory 504 may include operating system 505, one or more programming modules 506, and includes a web browser application. Operating system 505, for example, may be suitable for controlling computing device 500's operation. In one embodiment, programming modules 506 may include a scheduling manager 242, as described above , installed on computing device 500. Furthermore, embodiments of the invention may be practiced in conjunction with a graphics library, other operating systems, or any other application program and is not limited to any particular application or system. This basic configuration is illustrated in FIG. 5 by those components within a dashed line 508.

Computing device 500 may have additional features or functionality. For example, computing device 500 may also include additional data storage devices (removable and/or non-removable) such as, for example, magnetic disks, optical disks, or tape. Such additional storage is illustrated in FIG. 5 by a removable storage 509 and a non-removable storage 510.

As stated above, a number of program modules and data files may be stored in system memory 504, including operating system 505. While executing on processing unit 502, programming modules 506, such as the manager may perform processes including, for example, methods 300 and 400 as described above. The aforementioned processes are an example, and processing unit 502 may perform other processes. Other programming modules that may be used in accordance with embodiments of the present invention may include collaboration applications, project management applications, electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the manager 242 may be operated via application-specific logic integrated with other components of the computing device/system 500 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process.

The term computer readable media as used herein may include computer storage media. Computer storage media may include volatile and nonvolatile, removable and non-removable media implemented in any method or technology for storage of information, such as computer readable instructions, data structures, program modules, or other data. System memory 504, removable storage 509, and non-removable storage 510 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 500. Any such computer storage media may be part of device 500. Computing device 500 may also have input device(s) 512 such as a keyboard, a mouse, a pen, a sound input device, a touch input device, a eyes-tracking device, a motion capture device, etc. Output device(s) 514 such as a display, speakers, a printer, etc. may also be included. The aforementioned devices are examples and others may be used. Communication connection(s) 516 is configured to connect to other computing devices 518.

A camera and/or some other sensing device may be operative to record one or more users and capture motions and/or gestures made by users of a computing device. Sensing device may be further operative to capture spoken words, such as by a microphone and/or capture other inputs from a user such as by a keyboard and/or mouse (not pictured). The sensing device may comprise any motion detection device capable of detecting the movement of a user. For example, a camera may comprise a MICROSOFT KINECT® motion capture device comprising a plurality of cameras and a plurality of microphones.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

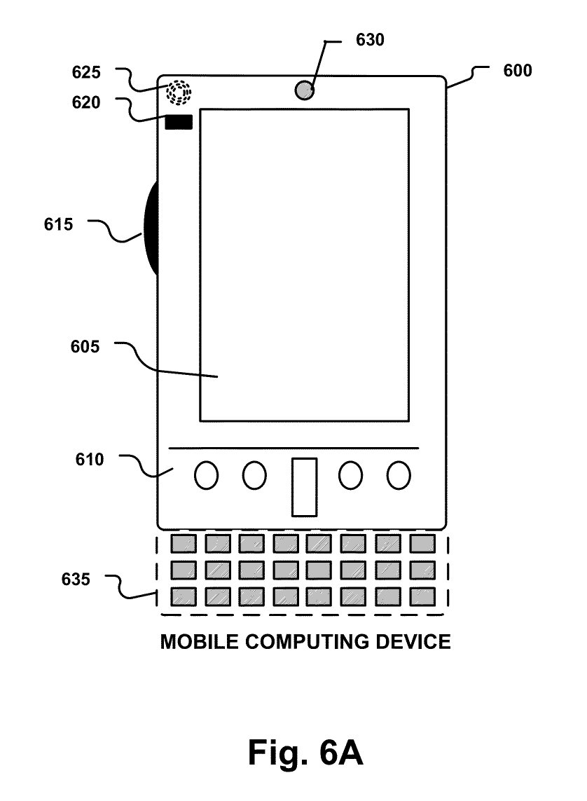

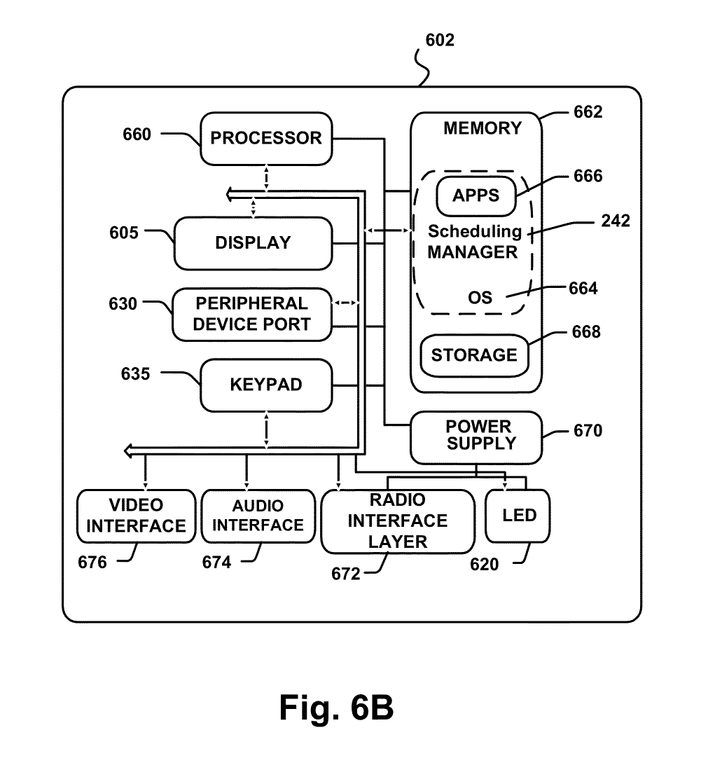

FIGS. 6A and 6B illustrate a suitable mobile computing environment, for example, a mobile telephone, a smartphone, a tablet personal computer, a laptop computer, and the like, with which embodiments of the invention may be practiced. With reference to FIG. 6A, an example mobile computing device 600 for implementing the embodiments is illustrated. In a basic configuration, mobile computing device 600 is a handheld computer having both input elements and output elements. Input elements may include touch screen display 605 and input buttons 610 that allow the user to enter information into mobile computing device 600. Mobile computing device 600 may also incorporate an optional side input element 615 allowing further user input. Optional side input element 615 may be a rotary switch, a button, or any other type of manual input element. In alternative embodiments, mobile computing device 600 may incorporate more or less input elements. For example, display 605 may not be a touch screen in some embodiments. In yet another alternative embodiment, the mobile computing device is a portable phone system, such as a cellular phone having display 605 and input buttons 610, 615. Mobile computing device 600 may also include an optional keypad 635. Optional keypad 635 may be a physical keypad or a “soft” keypad generated on the touch screen display.

Mobile computing device 600 incorporates output elements, such as display 605, which can display a graphical user interface (GUI). Other output elements include speaker 625 and LED light 620. Additionally, mobile computing device 600 may incorporate a vibration module (not shown), which causes mobile computing device 600 to vibrate to notify the user of an event. In yet another embodiment, mobile computing device 600 may incorporate a headphone jack (not shown) for providing another means of providing output signals.

Although described herein in combination with mobile computing device 600, in alternative embodiments the invention is used in combination with any number of computer systems, such as in desktop environments, laptop or notebook computer systems, multiprocessor systems, micro-processor based or programmable consumer electronics, network PCs, mini computers, main frame computers and the like. Embodiments of the invention may also be practiced in distributed computing environments where tasks are performed by remote processing devices that are linked through a communications network in a distributed computing environment; programs may be located in both local and remote memory storage devices. To summarize, any computer system having a plurality of environment sensors, a plurality of output elements to provide notifications to a user and a plurality of notification event types may incorporate embodiments of the present invention.

FIG. 6B is a block diagram illustrating components of a mobile computing device used in one embodiment, such as the computing device shown in FIG. 6A. That is, mobile computing device 600 can incorporate system 602 to implement some embodiments. For example, system 602 can be used in implementing a “smart phone” that can run one or more applications similar to those of a desktop or notebook computer such as, for example, browser, e-mail, scheduling, instant messaging, and media player applications. In some embodiments, system 602 is integrated as a computing device, such as an integrated personal digital assistant (PDA) and wireless phoneme.

One or more application programs 666 may be loaded into memory 662 and run on or in association with operating system 664. Examples of application programs include dialer programs, e-mail programs, PIM (personal information management) programs, word processing programs, spreadsheet programs, Internet browser programs, messaging programs, and so forth. System 602 also includes non-volatile storage 668 within memory 662. Non-volatile storage 668 may be used to store persistent information that should not be lost if system 602 is powered down. Applications 666 may use and store information in non-volatile storage 668, such as e-mail or other messages used by an e-mail application, and the like. A synchronization application (not shown) may also reside on system 602 and is programmed to interact with a corresponding synchronization application resident on a host computer to keep the information stored in non-volatile storage 668 synchronized with corresponding information stored at the host computer. As should be appreciated, other applications may be loaded into memory 662 and run on the mobile computing device 600, including the scheduling manager 242, described above.

System 602 has a power supply 670, which may be implemented as one or more batteries. Power supply 670 might further include an external power source, such as an AC adapter or a powered docking cradle that supplements or recharges the batteries.

System 602 may also include a radio 672 that performs the function of transmitting and receiving radio frequency communications. Radio 672 facilitates wireless connectivity between system 602 and the “outside world”, via a communications carrier or service provider. Transmissions to and from radio 672 may be conducted under control of OS 664. In other words, communications received by radio 672 may be disseminated to application programs 666 via OS 664, and vice versa. According to another embodiment, the OS 664 is an optional component and operations may be performed without the use of OS 664.

Radio 672 allows system 602 to communicate with other computing devices, such as over a network. Radio 672 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

This embodiment of system 602 is shown with two types of notification output devices; LED 620 that can be used to provide visual notifications and an audio interface 674 that can be used with speaker 625 to provide audio notifications. These devices may be directly coupled to power supply 670 so that when activated, they remain on for a duration dictated by the notification mechanism even though processor 660 and other components might shut down for conserving battery power. LED 620 may be programmed to remain on indefinitely until the user takes action to indicate the powered-on status of the device. Audio interface 674 is used to provide audible signals to and receive audible signals from the user. For example, in addition to being coupled to speaker 625, audio interface 674 may also be coupled to a microphone 620 to receive audible input, such as to facilitate a telephone conversation. In accordance with embodiments of the present invention, the microphone 620 may also serve as an audio sensor to facilitate control of notifications, as will be described below. System 602 may further include video interface 676 that enables an operation of on-board camera 630 to record still images, video stream, and the like.

A mobile computing device implementing system 602 may have additional features or functionality. For example, the device may also include additional data storage devices (removable and/or non-removable) such as, magnetic disks, optical disks, or tape. Such additional storage is illustrated in FIG. 6B by storage 668. Computer storage media may include volatile and nonvolatile, removable and non-removable media implemented in any method or technology for storage of information, such as computer readable instructions, data structures, program modules, or other data.

Data/information generated or captured by the mobile computing device 600 and stored via the system 602 may be stored locally on the mobile computing device 600, as described above, or the data may be stored on any number of storage media that may be accessed by the device via the radio 672 or via a wired connection between the mobile computing device 600 and a separate computing device associated with the mobile computing device 600, for example, a server computer in a distributed computing network such as the Internet. As should be appreciated such data/information may be accessed via the mobile computing device 600 via the radio 672 or via a distributed computing network. Similarly, such data/information may be readily transferred between computing devices for storage and use according to well-known data/information transfer and storage means, including electronic mail and collaborative data/information sharing systems.

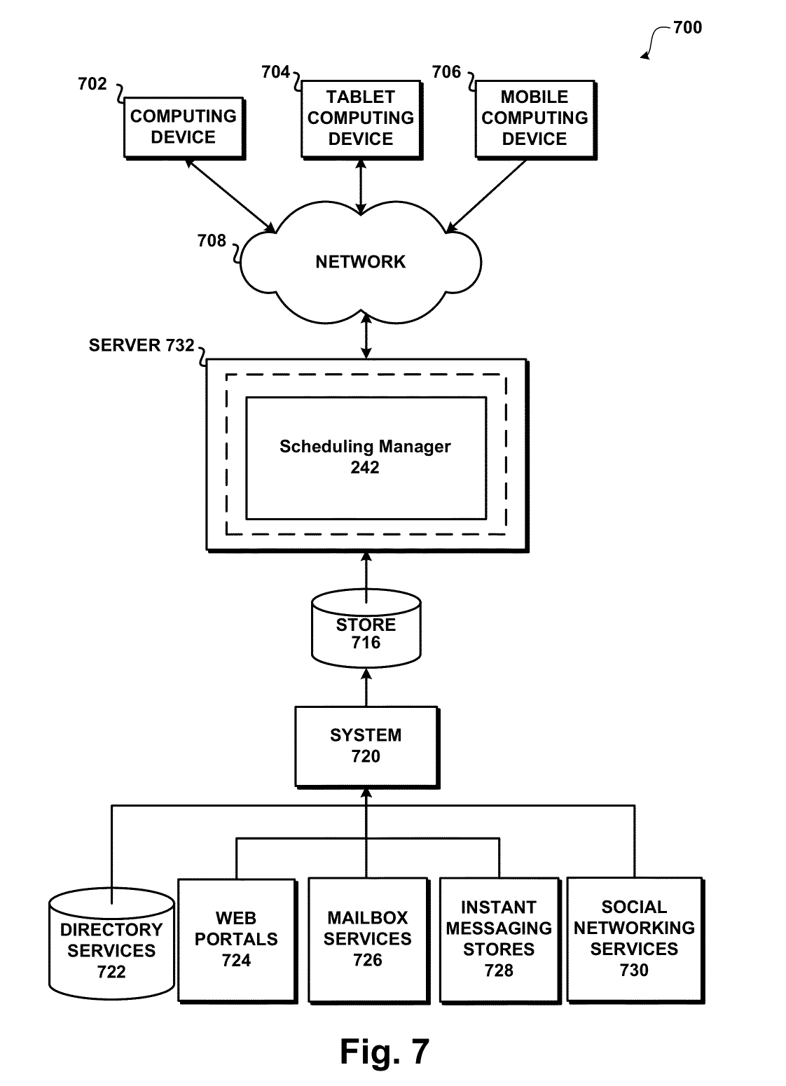

FIG. 7 illustrates a system architecture 700 for scheduling user jobs across tenants, as described above.

Components managed via the scheduling manager 242 may be stored in different communication channels or other storage types. For example, components along with information from which they are developed may be stored using directory services 722, web portals 724, mailbox services 726, instant messaging stores 728 and social networking sites 730. The systems/applications 242, 720 may use any of these types of systems or the like for enabling management and storage of components in a store 716. A server 732 may provide communications for managed components and content to clients. As one example, server 732 may provide collaboration related services. Server 732 may provide services and content over the web to clients through a network 708. Examples of clients that may utilize server 732 include computing device 702, which may include any general purpose personal computer, a tablet computing device 704 and/or mobile computing device 706 which may include smart phones. Any of these devices may obtain display component management communications and content from the store 716.

Embodiments of the present invention are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for scheduling jobs per user across tenants, comprising:
choosing a tenant to service from tenants that each includes users;
servicing the tenant including servicing at least a portion of the users of the tenant; and
receiving servicing information that relates to an unserviced user of the tenant that remains unserviced after servicing the tenant that is used when choosing the tenant to service.

2. The method of claim 1, wherein receiving the servicing information comprises receiving a service time for the tenant that indicates a time when the tenant was serviced without servicing the unserviced user.

3. The method of claim 2, further comprising sorting the tenants based on the servicing information.

4. The method of claim 2, wherein choosing the tenant to service comprises determining the tenant with an oldest unserviced user based on the servicing information.

5. The method of claim 1, further comprising ordering the tenants according to the servicing information received from each tenant and servicing each of the tenants according to the ordering.

6. The method of claim 1, wherein servicing the tenant comprises servicing the tenant using a remote machine.

7. The method of claim 1, further comprising storing the servicing information.

8. The method of claim 1, further comprising starting a scheduler on a recurring timer job and using the scheduler to initiate the servicing of the tenant.

9. The method of claim 8, further comprising obtaining a list of the tenants to service each time the scheduler starts.

10. A computer-readable medium having computer-executable instructions for scheduling jobs per user across tenants, comprising:
choosing a tenant to service from tenants that each includes users;
servicing the tenant including servicing at least a portion of the users of the tenant; and
receiving servicing information that relates to a time of an unserviced user of the tenant that remains unserviced after servicing the tenant that is used when choosing the tenant to service.

11. The computer-readable medium of claim 10, further comprising sorting the tenants based on the servicing information that includes a time of a first unserviced user.

12. The computer-readable medium of claim 10, wherein choosing the tenant to service comprises determining the tenant with an oldest unserviced user based on the servicing information.

13. The computer-readable medium of claim 10, further comprising ordering the tenants according to the servicing information received from each tenant and servicing each of the tenants according to the ordering.

14. The computer-readable medium of claim 10, further comprising starting a scheduler on a recurring timer job and using the scheduler to initiate the servicing of each of the tenants.

15. The computer-readable medium of claim 14, further comprising obtaining a list of the tenants to service each time the scheduler starts.

16. A system for scheduling jobs per user across tenants, comprising:
a processor and a computer-readable medium;
an operating environment stored on the computer-readable medium and executing on the processor; and
a manager operating under the control of the operating environment and operative to actions comprising:
choosing a tenant to service from tenants that each includes users;
servicing the tenant including servicing at least a portion of the users of the tenant; and
receiving servicing information that relates to a time of an unserviced user of the tenant that remains unserviced after servicing the tenant that is used when choosing the tenant to service.

17. The system of claim 10, further comprising sorting the tenants based on the servicing information that includes a time of a first unserviced user for each of the tenants.

18. The system of claim 10, further comprising ordering the tenants according to the servicing information received from each tenant and servicing each of the tenants according to the ordering.

19. The system of claim 10, further comprising starting a scheduler on a recurring timer job and using the scheduler to initiate the servicing of each of the tenants.

20. The system of claim 16, further comprising obtaining a list of the tenants to service each time a scheduler starts.
